(19) United States
(12) Patent Application Publication
(10) Pub. No.: US 2026/0339162 A1
(43) Pub. Date: Oct. 29, 2026

(54) SUB-190 NANOMETER DEEP-ULTRAVIOLET LASER BEAM GENERATION

(71) Applicant: Coherent, Inc., Santa Clara, CA (US)

(72) Inventors: Norman HODGSON, Belmont, CA (US); Michael SCRIPSICK, Lafayette, NJ (US)

(73) Assignee: Coherent, Inc., Santa Clara, CA (US)

(21) Appl. No.: 19/298,909

(22) Filed: Aug. 13, 2025

Related U.S. Application Data
(60) Provisional application No. 63/686,049, filed on Aug. 22, 2024.

(51) Int. Cl. G02F 1/35; G02F 1/355; H01S 3/00

(52) U.S. Cl. CPC G02F 1/3534; G02F 1/354; G02F 1/3551; H01S 3/0092; G02F 2203/11; H01S 2302/00

(57) ABSTRACT

A laser apparatus for generating a sub-190 nanometer laser beam includes a deep-ultraviolet solid-state laser source to generate an initial deep-ultraviolet laser beam, at least one mid-infrared solid-state laser source to generate at least one respective mid-infrared laser beam, and at least one lithium triborate crystal to generate an output deep-ultraviolet laser beam from the initial deep-ultraviolet and mid-infrared laser beams via sum-frequency generation. Each mid-infrared solid-state laser source includes (a) a holmium-, thulium-, or chromium-doped gain crystal or gain fiber or (b) an optically-pumped semiconductor gain material to generate the respective mid-infrared laser beam. The laser apparatus may be configured for continuous-wave and pulsed operation, thus offering versatile solutions for applications requiring DUV laser radiation below 190 nanometers. Advantageously, the present approach relies on lithium triborate. Lithium triborate crystals can be grown with the quality and dimensions needed for industrial applications.

### CROSS-REFERENCE TO RELATED APPLICATIONS

This application claims the benefit of U.S. Provisional Application No. 63/686,049, filed Aug. 22, 2024, the entire contents of which is incorporated herein by reference.

### TECHNICAL FIELD OF THE INVENTION

The present invention relates in general to the generation of deep-ultraviolet laser beams, both pulsed and continuous-wave, with wavelengths shorter than 190 nanometers. The present invention relates in particular to all-solid-state solutions that reach the sub-190 nm wavelengths through sum-frequency generation in nonlinear crystals suitable for industrial applications.

### DISCUSSION OF BACKGROUND ART

Deep-ultraviolet (DUV) laser sources are of importance in a variety of industrial and scientific applications, including precise machining, photolithography, semiconductor inspection, materials analysis, and photoemission spectroscopy. The deep-ultraviolet wavelength range spans from 300 nanometers (nm) down to 100 nm. In machining, photolithography, and semiconductor inspection, the short wavelength of DUV laser radiation enables the formation or detection of features smaller than those achievable or detectable with longer-wavelength ultraviolet laser radiation or visible laser radiation.

Several different approaches have been used to generate DUV laser radiation. Excimer lasers in particular have been widely used for DUV generation, especially in semiconductor photolithography. Excimer lasers have a gaseous gain medium and generate ultraviolet nanosecond laser pulses. Excimer lasers can produce high average powers in the watt to kilowatt range. Unfortunately, excimer lasers have significant disadvantages. For example, their output wavelengths are limited to a small number of specific spectral lines, such as 193 nm with argon fluoride gas and 157 nm with fluorine gas, and the gaseous gain medium is corrosive and, in some cases, toxic.

Solid-state lasers, based on a solid-state gain medium in the form of a crystal or a glass, present an attractive alternative to excimer lasers. Solid-state lasers are smaller and more affordable, have efficient lasing action, generate laser beams with excellent beam quality, have a lower cost of operation, and do not involve corrosive or toxic gases. Typically, the solid-state laser gain medium is doped with rare-earth ions, such as neodymium, erbium, or ytterbium. When energized in a laser resonator or amplifier, the particular rare-earth ions neodymium, erbium, or ytterbium generate near-infrared laser radiation. So far, no diode-pumped or flash-pumped solid-state laser is capable of directly generating DUV laser radiation. Instead, frequency conversion in optically-nonlinear media is used to reach DUV wavelengths.

Nonlinear crystals are routinely employed to convert the output beam of a solid-state laser to a shorter wavelength. Through multiple stages of frequency conversion in nonlinear crystals, DUV laser radiation can be generated from the output of a near-infrared solid-state laser. For example, a solid-state laser with a neodymium-doped gain crystal can generate a 1064 nm laser beam, which can then be used to generate a 266 nm laser beam through two sequential stages of second-harmonic generation (i.e., frequency doubling). Similarly, through two sequential stages of second-harmonic generation, a 244 nm laser beam can be produced from a 976 nm laser beam generated with an ytterbium-doped gain crystal. Laser beams of, e.g., 244 or 266 nm, can be mixed with an infrared beam in another nonlinear crystal to generate a DUV laser beam with a shorter wavelength through sum-frequency generation.

Difficulties arise when seeking to reach more deeply into the DUV range, particularly into the sub-190 nm range. Nonlinear crystals become absorptive below a certain wavelength. The nonlinear-crystal materials most often used for frequency conversion into the sub-200 nm range are beta barium borate (BBO), cesium lithium borate (CLBO), and cesium borate (CBO). However, the absorption edge is at 189 nm for BBO and 180 nm for CLBO and CBO, thus making it difficult to penetrate into the sub-190 nm range. In addition, efficient frequency-conversion in a nonlinear crystal requires phase-matching between the involved laser beams. Each type of frequency-conversion process in each nonlinear-crystal material is subject to a wavelength limit, for the frequency-converted output laser beam, below which the phase-matching condition cannot be met. Depending on the type of frequency-conversion process, this phase-matching wavelength limit is in the range between 165 and 280 nm for the aforementioned materials.

A more recently developed nonlinear-crystal material, potassium beryllium fluoroborate (KBBF), has opened new possibilities for frequency conversion into the sub-190 nm wavelength range. The absorption edge for KBBF is at 153 nm, and the phase-matching condition can be met for wavelengths down to 164 nm for second-harmonic generation and 153 nm for sum-frequency generation. Direct second-harmonic generation down to wavelengths as low as 167 nm has been demonstrated with KBBF. However, KBBF cannot be grown with the quality and dimensions required for most industrial applications.

### SUMMARY OF THE INVENTION

We have recognized that, with the continuing size-reduction of semiconductor devices and features, DUV laser radiation with wavelengths shorter than 190 nm will be needed to perform critical inspection tasks in the semiconductor industry. All-solid-state solutions for generating such sub-190 nm laser radiation are preferred for multiple reasons, including energy efficiency, cost, performance, and convenience.

Disclosed herein is an all-solid-state approach to generating sub-190 nm laser radiation via sum-frequency generation in lithium triborate (LBO). The absorption edge for LBO is at 158 nm, and the phase-matching condition for sum-frequency generation can be met for wavelengths down to about 174 nm. The input beams to the present sum-frequency generation process in LBO are (a) a DUV laser beam with a wavelength longer than 190 nm and (b) a mid-infrared laser beam. These input beams are produced by solid-state laser sources. To generate the mid-infrared laser beam with a wavelength that enables generation of sub-190 nm wavelengths, the mid-infrared solid-state laser source utilizes either (a) a gain crystal or fiber doped with holmium, thulium, or chromium or (b) an optically-pumped semiconductor gain material.

Laser apparatuses according to the present approach may be configured for either one of continuous-wave and pulsed operation, thus offering versatile solutions for applications requiring DUV laser radiation below 190 nm. Advantageously, the present approach relies on LBO which, unlike KBBF, can be grown with the quality and dimensions needed for industrial applications. The presently disclosed laser apparatuses may be applied to semiconductor inspection as well as other processes, such as photolithography and refractive-index modifications in transparent materials.

In one aspect of the invention, a laser apparatus for generating a sub-190 nm laser beam includes a deep-ultraviolet solid-state laser source to generate an initial deep-ultraviolet laser beam, at least one mid-infrared solid-state laser source to generate at least one respective mid-infrared laser beam, and at least one lithium triborate crystal to generate an output deep-ultraviolet laser beam from the initial deep-ultraviolet and mid-infrared laser beams via sum-frequency generation. Each of the at least one mid-infrared solid-state laser source includes (a) a respective holmium-, thulium-, or chromium-doped gain crystal or gain fiber or (b) a respective optically-pumped semiconductor gain material to generate the respective mid-infrared laser beam. The output deep-ultraviolet laser beam has a wavelength shorter than 190 nm.

In some embodiments, a laser apparatus for generating a sub-190 nanometer laser beam is provided, comprising: a deep-ultraviolet solid-state laser source to generate an initial deep-ultraviolet laser beam; at least one mid-infrared solid-state laser source to generate at least one respective mid-infrared laser beam, each of the at least one mid-infrared solid-state laser source including (a) a respective holmium-, thulium-, or chromium-doped gain crystal or gain fiber or (b) a respective optically-pumped semiconductor gain material to generate the respective mid-infrared laser beam; and at least one lithium triborate crystal to generate an output deep-ultraviolet laser beam from the initial deep-ultraviolet and mid-infrared laser beams via sum-frequency generation, the output deep-ultraviolet laser beam having a wavelength shorter than 190 nanometers.

In some embodiments, the sum-frequency generation in each of the at least one lithium triborate crystal utilizes one of the at least one mid-infrared laser beam, the sum-frequency generation in a first one of the at least one lithium triborate crystal utilizes also the initial deep-ultraviolet laser beam, and the sum-frequency generation in any non-first one of the at least one lithium triborate crystal utilizes also an intermediate deep-ultraviolet laser beam generated by sum-frequency generation in a preceding one of the at least one lithium triborate crystal.

In some embodiments, the initial deep-ultraviolet laser beam has a wavelength between 190 and 230 nanometers.

In some embodiments, the mid-infrared laser beam generated by each of the at least one mid-infrared solid-state laser source has a wavelength between 1850 and 2600 nanometers.

In some embodiments, the at least one mid-infrared solid-state laser source consists of a single mid-infrared solid-state laser source, and the at least one lithium triborate crystal consists of a single lithium triborate crystal.

In some embodiments: the at least one lithium triborate crystal includes a series of lithium triborate crystals such that the output deep-ultraviolet laser beam is a product of sequential sum-frequency generation in the series of lithium triborate crystals; the at least one mid-infrared solid-state laser source consists of a single mid-infrared solid-state laser source generating a single mid-infrared laser beam; and the sum-frequency generation in each of the lithium triborate crystals of the series utilizes the single mid-infrared laser beam.

In some embodiments, the series of lithium triborate crystals consists of two lithium triborate crystals.

In some embodiments: the at least one lithium triborate crystal includes a series of lithium triborate crystals such that the output deep-ultraviolet laser beam is a product of sequential sum-frequency generation in the series of lithium triborate crystals; the at least one mid-infrared solid-state laser source includes a series of mid-infrared solid-state laser sources generating a respective series of mid-infrared laser beams; and the sum-frequency generation in each of the lithium triborate crystals of the series utilizes a respective one of the series of mid-infrared laser beams.

In some embodiments, the series of lithium triborate crystals consists of two lithium triborate crystals, and the series of mid-infrared solid-state laser sources consists of two mid-infrared solid-state laser sources.

In some embodiments, the deep-ultraviolet and mid-infrared solid-state laser sources are continuous-wave laser sources, and the mid-infrared laser beam, the initial deep-ultraviolet laser beam, and the output deep-ultraviolet laser beam are continuous-wave laser beams.

In some embodiments: the at least one mid-infrared solid-state laser source consists of a single mid-infrared solid-state laser source generating a single mid-infrared laser beam as an intracavity laser beam propagating in a laser resonator of the single mid-infrared solid-state laser source; and each of the at least one lithium triborate crystal is positioned in the laser resonator in a propagation path of the intracavity laser beam.

In some embodiments, the at least one lithium triborate crystal consists of a single lithium triborate crystal.

In some embodiments, the deep-ultraviolet solid-state laser source includes: a first solid-state laser source to generate a first near-infrared continuous-wave laser beam; a plurality of nonlinear crystals to generate a fourth harmonic of the first near-infrared continuous-wave laser beam; a second solid-state laser source; and an additional nonlinear crystal positioned in a laser resonator of the second solid-state laser source to generate the initial deep-ultraviolet laser beam from sum-frequency mixing of an intracavity near-infrared continuous-wave laser beam, propagating in the laser resonator of the second solid-state laser source, and the fourth harmonic of the first near-infrared continuous-wave laser beam.

In some embodiments, the initial deep-ultraviolet laser beam has a wavelength of less than 200 nanometers.

In some embodiments, the at least one lithium triborate crystal includes a series of lithium triborate crystals such that the output deep-ultraviolet laser beam is a product of sequential sum-frequency generation in the series of lithium triborate crystals.

In some embodiments, the series of lithium triborate crystals consists of two lithium triborate crystals.

In some embodiments, the deep-ultraviolet solid-state laser source includes: a first solid-state laser source to generate a first near-infrared continuous-wave laser beam; a plurality of nonlinear crystals to generate a fourth harmonic of the first near-infrared continuous-wave laser beam; a second solid-state laser source with a laser resonator and an ion-doped gain medium, disposed in the laser resonator, to generate a second near-infrared continuous-wave laser beam as an intracavity laser beam propagating in the laser resonator; and an additional nonlinear crystal positioned in a laser resonator of the second solid-state laser source to generate the deep-ultraviolet laser beam from sum-frequency mixing of an intracavity near-infrared continuous-wave laser beam, propagating in the laser resonator of the second solid-state laser source, and the fourth harmonic of the first near-infrared continuous-wave laser beam.

In some embodiments, the deep-ultraviolet laser beam has a wavelength between 210 and 225 nanometers.

In some embodiments: the at least one mid-infrared solid-state laser source includes a series of mid-infrared solid-state laser sources generating a respective series of mid-infrared laser beams, each mid-infrared laser beam of the series being an intracavity laser beam propagating in a laser resonator of the respective mid-infrared solid-state laser source; and the at least one lithium triborate crystal includes a series of lithium triborate crystals such that the output deep-ultraviolet laser beam is a product of sequential sum-frequency generation in the series of lithium triborate crystals, each lithium triborate crystal of the series of lithium triborate crystals being positioned in the laser resonator of a respective one of the mid-infrared solid-state laser sources.

In some embodiments, the series of mid-infrared solid-state laser sources consists of two mid-infrared solid-state laser sources, and the series of lithium triborate crystals consists of two lithium triborate crystals.

In some embodiments, the at least one mid-infrared solid-state laser source consists of a single mid-infrared solid-state laser source generating a single mid-infrared laser beam, the laser apparatus further comprising a single resonant-enhancement cavity to resonantly enhance the single mid-infrared laser beam, each of the at least one lithium triborate crystal being positioned in the single resonant-enhancement cavity in a propagation path of the single mid-infrared laser beam as resonantly enhanced.

In some embodiments, the at least one lithium triborate crystal consists of a single lithium triborate crystal.

In some embodiments, the at least one lithium triborate crystal includes a series of lithium triborate crystals such that the output deep-ultraviolet laser beam is a product of sequential sum-frequency generation in the series of lithium triborate crystals.

In some embodiments, the series consists of two lithium triborate crystals.

In some embodiments: the at least one lithium triborate crystal includes a series of lithium triborate crystals such that the output deep-ultraviolet laser beam is a product of sequential sum-frequency generation in the series of lithium triborate crystals; the at least one mid-infrared solid-state laser source consists of a single mid-infrared solid-state laser source generating a single mid-infrared laser beam; the laser apparatus further comprises a series of resonant-enhancement cavities to resonantly enhance respective portions of the single mid-infrared laser beam; and each lithium triborate crystal of the series is positioned in a respective one of the resonant-enhancement cavities in a propagation path of the respective portions of the single mid-infrared laser beam as resonantly enhanced.

In some embodiments, the initial deep-ultraviolet and mid-infrared solid-state laser sources are pulsed laser sources, and the mid-infrared laser beam, the initial deep-ultraviolet laser beam, and the output deep-ultraviolet laser beam are pulsed laser beams.

In some embodiments, wherein each laser beam contributing to sum-frequency generation in each of the least one lithium triborate crystal makes only a single pass through the respective lithium triborate crystal.

In some embodiments, the at least one lithium triborate crystal consists of a single lithium triborate crystal.

In some embodiments, the at least one lithium triborate crystal includes a series of lithium triborate crystals such that the output deep-ultraviolet laser beam is a product of sequential sum-frequency generation in the series of lithium triborate crystals.

In some embodiments, the series of lithium triborate crystals consists of two lithium triborate crystals.

In some embodiments, the at least one mid-infrared solid-state laser source consists of a single mid-infrared solid-state laser source generating a single mid-infrared laser beam.

In some embodiments: the single mid-infrared laser beam has a wavelength between 200 and 220 nanometers; the at least one lithium triborate crystal includes a series of two lithium triborate crystals such that the deep-ultraviolet output laser beam is a product of sequential sum-frequency generation in the two lithium triborate crystals; and the output deep-ultraviolet laser beam has a wavelength between 164 and 182 nanometers.

In some embodiments, the deep-ultraviolet solid-state laser source includes: a solid-state laser source with an ion-doped gain medium to generate a near-infrared pulsed laser beam; and a plurality of nonlinear crystals to generate the initial deep-ultraviolet laser beam as a fifth harmonic of the near-infrared pulsed laser beam.

In some embodiments, any one or more features of any of the embodiments listed above may be combined in whole or in part with one another and/or with any other features described elsewhere herein.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 is a block diagram of a laser apparatus for generating a sub-190 nm laser beam through sum-frequency generation in an LBO crystal, according to an embodiment.

FIG. 2 is a block diagram of a laser apparatus for generating a sub-190 nm laser beam through sum-frequency generation in a series of LBO crystals, according to an embodiment.

FIG. 3 is a block diagram of a laser apparatus for generating a sub-190 nm laser beam through sum-frequency generation in a series of LBO crystals that each receives a mid-IR laser beam from a different respective mid-IR laser source, according to an embodiment.

FIG. 4 illustrates a cw laser apparatus for generating a sub-190 nm cw laser beam through a single stage of intracavity sum-frequency generation in an LBO crystal positioned in the laser resonator of a cw mid-IR laser source, according to an embodiment.

FIG. 5 illustrates a cw laser apparatus for generating a sub-190 nm cw laser beam through sequential intracavity sum-frequency generation in two LBO crystals positioned in the laser resonator of a cw mid-IR laser source, according to an embodiment.

FIG. 6 illustrates a cw laser apparatus for generating a sub-190 nm cw laser beam through two sequential intracavity sum-frequency generation stages in two separate cw mid-IR laser sources, according to an embodiment.

FIG. 7 illustrates a cw laser apparatus for generating a sub-190 nm cw laser beam through a single stage of sum-frequency generation in an LBO crystal positioned in a resonant-enhancement cavity, according to an embodiment.

FIG. 8 illustrates a cw DUV laser source for generating an initial DUV beam via two sequential stages of second-harmonic generation followed by intracavity sum-frequency generation, according to an embodiment.

FIG. 9 illustrates a cw laser apparatus for generating a sub-190 nm cw laser beam through a single stage of intracavity sum-frequency generation in an LBO crystal positioned in the laser resonator of a cw mid-IR laser source, according to an embodiment.

FIG. 10 illustrates a cw laser apparatus for generating a sub-190 nm cw laser beam through sequential intracavity sum-frequency generation in two LBO crystals positioned in the laser resonator of a cw mid-IR laser, according to an embodiment.

FIG. 11 illustrates a pulsed DUV laser source for generating an initial pulsed DUV beam as the fifth harmonic of a pulsed near-IR laser beam, according to an embodiment.

FIG. 12 illustrates a pulsed laser apparatus for generating a sub-190 nm pulsed laser beam through sequential sum-frequency generation in two LBO crystals, according to an embodiment.

### DETAILED DESCRIPTION OF THE INVENTION

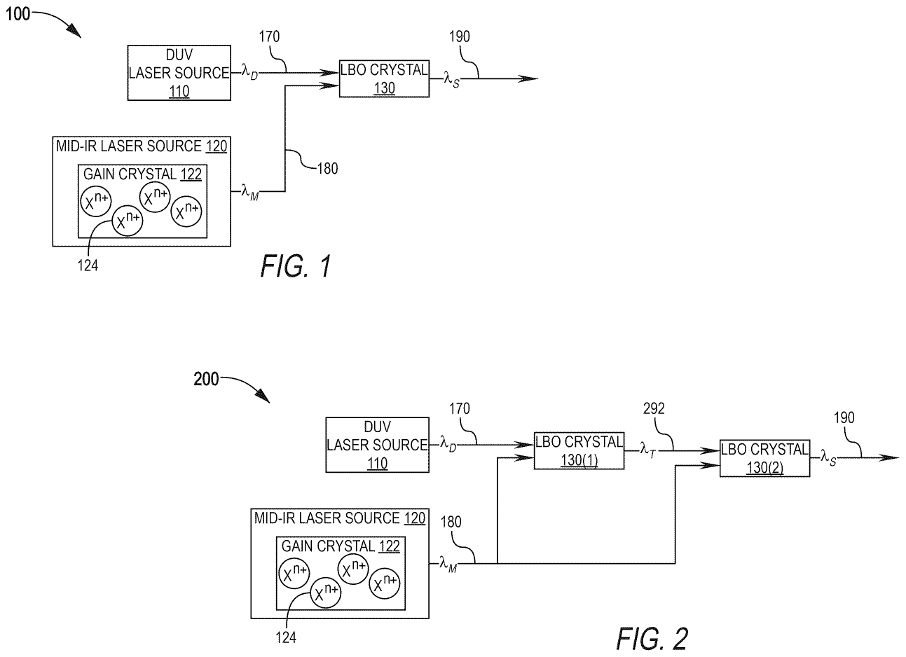

Referring now to the drawings, wherein like components are designated by like numerals, FIG. 1 is a block diagram of one laser apparatus 100 for generating a sub-190 nm laser beam through sum-frequency generation in an LBO crystal. Apparatus 100 includes a DUV laser source 110, a mid-IR laser source 120, and an LBO crystal 130. DUV source 110 and mid-IR source 120 are solid-state laser sources. DUV laser source 110 generates an initial DUV laser beam 170 having a wavelength λ_{D} that exceeds 190 nm. Mid-IR laser source 120 generates a mid-IR laser beam 180 having a wavelength λ_{M}. Initial DUV beam 170 and mid-IR beam 180 are combined in LBO crystal 130 to generate a sub-190 nm DUV output laser beam 190 through sum-frequency generation. The wavelength λ_{S} of DUV output beam 190 may be in the range from 174 to 190 nm.

Herein, “mid-IR” refers to any part of the portion of the infrared spectral range that spans from 1300 to 3000 nm, and “near-IR” refers to the portion of the infrared spectral range that spans from the longer-wavelength limit of the visible spectral range (approximately 750 nm) to 1300 nm. Also herein, a “solid-state” laser is a laser that has (a) a solid gain medium doped with optically active ions or (b) a semiconductor laser gain material. The solid gain medium may be in the form of a crystal or a glass. The class of solid-state lasers includes bulk lasers, fiber lasers and other types of waveguide lasers, and optically pumped semiconductor lasers.

LBO crystal 130 may be a composite crystal, for example a tandem crystal having two connected pieces of LBO with opposite crystal lattice orientations to compensate for spatial walk-off.

DUV source 110 may include one or more nonlinear crystals to generate initial DUV beam 170 from a longer-wavelength laser beam via second-harmonic generation and/or sum-frequency generation. The wavelength λ_{D} of initial DUV beam 170 may be in the range between 190 and 210 nm.

Mid-IR source 120 includes a solid-state gain medium 122. In the depicted embodiment, gain medium 122 is a gain crystal or gain fiber doped with optically-active ions 124. Optically-active ions 124 are holmium, thulium, or chromium ions that produce mid-IR beam 180 with a wavelength λ_{M} that is sufficiently short to reach the sub-190 nm wavelength range while meeting the phase-matching condition. In another embodiment, not depicted, gain medium 122 is an optically-pumped semiconductor gain material capable of producing mid-IR beam 180 with a wavelength λ_{M} that is sufficiently short to reach the sub-190 nm wavelength range while meeting the phase-matching condition. The wavelength λ_{M} of mid-IR beam 180 may be near 2 micrometers (μm), for example in the range between 1850 and 2600 nm.

In one embodiment, gain medium 122 is a holmium-doped yttrium-aluminum garnet (YAG) crystal generating mid-IR beam 180 with a wavelength λ_{M} of 2090 nm, or a holmium-doped yttrium lithium fluoride (YLF) crystal generating mid-IR beam 180 with a wavelength λ_{M} of 2060 nm. In another embodiment, gain medium 122 is a thulium-doped yttrium-aluminum garnet (YAG) crystal generating mid-IR beam 180 with a wavelength λ_{M} of 2010 nm, or a thulium-doped yttrium lithium fluoride (YLF) crystal generating mid-IR beam 180 with a wavelength λ_{M} of 1908 nm. In yet another embodiment, gain medium 122 is a chromium-doped zinc selenide crystal generating mid-IR beam 180 with a center wavelength λ_{M} in the range of 2000 to 2600 nm or a chromium-doped zinc sulfite crystal generating mid-IR beam 180 with a center wavelength λ_{M} of in the range of 2000 to 2600 nm.

FIG. 2 is a block diagram of one laser apparatus 200 for generating a sub-190 nm laser beam through sum-frequency generation in a series of LBO crystals. Apparatus 200 is similar to apparatus 100 except for including a series of LBO crystals 130. In the depicted example, the series of LBO crystals 130 consists of two LBO crystals 130, labeled 130(1) and 130(2). Without departing from the scope hereof, the series of LBO crystals 130 may include more than two LBO crystals 130.

In apparatus 200, initial DUV beam 170 is combined with at least a portion of mid-IR beam 180 in the first LBO crystal 130(1) to generate an intermediate DUV laser beam 292 with a shorter wavelength λ_{T} than the wavelength λ_{D} of initial DUV beam 170. In the depicted example with only two LBO crystals 130, intermediate DUV beam 292 is then combined with another portion of mid-IR beam 180 in the last LBO crystal 130(2) of the series to generate DUV output beam 190. In embodiments including more than two LBO crystals 130, intermediate DUV beam 292 is instead combined with a portion of mid-IR beam 180 in a next LBO crystal 130 of the series to generate another intermediate DUV laser beam having a shorter wavelength than the intermediate DUV beam incident thereon, etc., until the last LBO crystal 130 of the series generates DUV output beam 190 having the shortest wavelength produced by any of the LBO crystals 130 of the series. More generally, apparatus 200 utilizes a series of at least two sum-frequency generation stages to shorten the generated DUV wavelength in a stepwise manner.

Since apparatus 200 incorporates at least two sequential sum-frequency generation stages, apparatus 200 may be suitable for reaching further into the DUV range than apparatus 100 and/or operate with a DUV source 110 that generates initial DUV beam 170 with a longer wavelength than in apparatus 100. In one example, apparatus 200 generates DUV output beam 190 with a wavelength in a sub-190 nm range extending down to 150 nm. In another example, apparatus 200 generates initial DUV beam 170 with a wavelength in the range between 200 and 230 nm.

In apparatus 200, mid-IR beam 180 may be split into two or more separate sub-beams that are each directed to a respective one of the two of more LBO crystals 130, as shown in FIG. 2. Alternatively, the portion of mid-IR beam 180 that reaches any non-first LBO crystal 130 of the series may be a remaining portion of mid-IR beam 180 that has passed through each preceding LBO crystal 130 of the series without being frequency-converted.

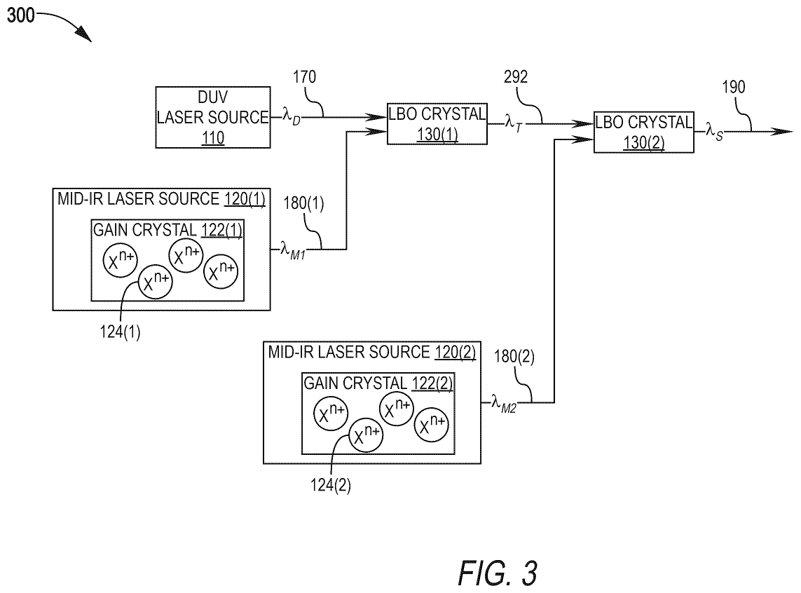

FIG. 3 is a block diagram of one laser apparatus 300 for generating a sub-190 nm laser beam through sum-frequency generation in a series of LBO crystals that each receives a mid-IR laser beam from a different respective mid-IR laser source. Apparatus 300 is similar to apparatus 200 except that each LBO crystal 130 receives a mid-IR beam 180 generated by a different mid-IR source 120. Although only two LBO crystals 130 and associated mid-IR sources 120 are depicted in FIG. 3, apparatus 300 may include more than two LBO crystals 130 and associated mid-IR sources 120.

Due to the additional mid-IR sources 120, apparatus 300 may be more complex to build and operate than apparatus 200. On the other hand, apparatus 300 allows for different LBO crystals 130 of the series receiving mid-IR beams 180 with different respective wavelengths. This provides an opportunity for further optimizing the sum-frequency generation processes, as compared to apparatus 200. For example, the two mid-IR sources 120 shown in FIG. 3 may generate their respective mid-IR beams 180 with wavelengths λ_{M1} and λ_{M2} that are different from each other.

Each of apparatuses 100, 200, and 300 may be configured for continuous-wave (cw) or pulsed operation. Additionally, although not shown, each LBO crystal 130 may be located within the mid-IR source 120 that generates the corresponding mid-IR beam 180.

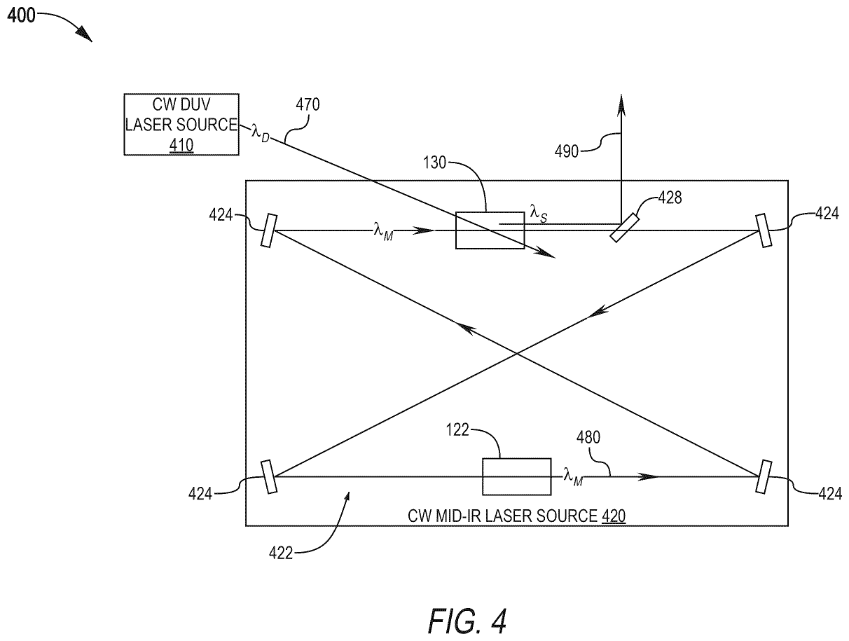

FIG. 4 illustrates one cw laser apparatus 400 for generating a sub-190 nm cw laser beam through a single stage of intracavity sum-frequency generation in an LBO crystal positioned in the laser resonator of a cw mid-IR laser source. Apparatus 400 is a cw embodiment of apparatus 100 that utilizes intracavity frequency conversion. Apparatus 400 includes a cw DUV laser source 410, a cw mid-IR laser source 420, and LBO crystal 130. LBO crystal 130 is positioned within mid-IR source 420.

Mid-IR source 420 includes a laser resonator 422 defined by a plurality of mirrors 424 and including gain medium 122. In the depicted embodiment, resonator 422 is a ring resonator. Alternatively, resonator 422 may be a linear resonator. Lasing action in gain medium 122 generates an intracavity cw mid-IR laser beam 480 propagating in resonator 422. LBO crystal 130 is positioned in resonator 422 in the propagation path of intracavity mid-IR beam 480. A cw DUV laser beam 470 generated by DUV source 410 is overlapped with intracavity mid-IR beam 480 in LBO crystal 130 to generate a cw DUV output laser beam 490. By virtue of LBO crystal 130 being positioned in resonator 422, the sum-frequency generation process benefits from the relatively high intracavity mid-IR power. DUV output beam 490 may be extracted from resonator 422 by a dichroic mirror 428 (as depicted), or through one of mirrors 424 if implemented with a dichroic coating.

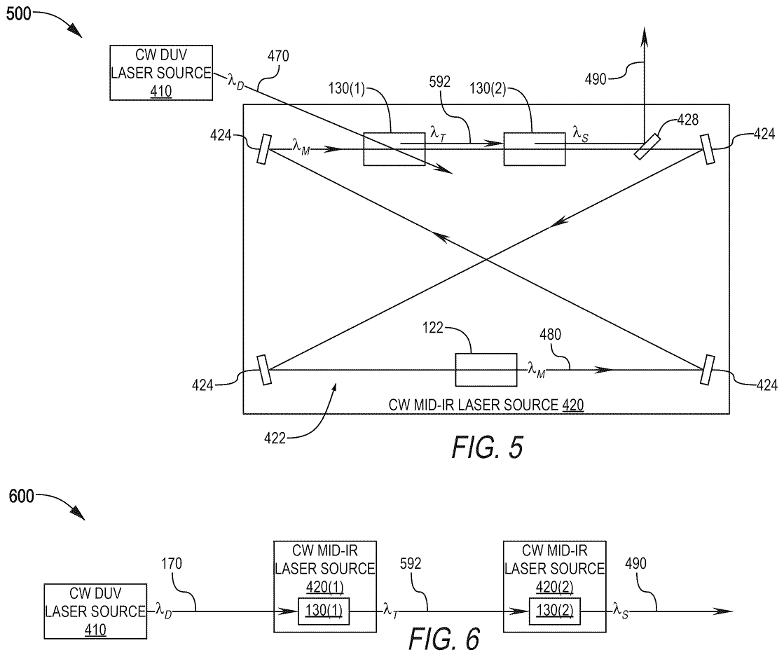

FIG. 5 illustrates one cw laser apparatus 500 for generating a sub-190 nm cw laser beam through sequential intracavity sum-frequency generation in two LBO crystals positioned in the laser resonator of a cw mid-IR laser source. Apparatus 500 is a cw embodiment of apparatus 200 that utilizes intracavity frequency conversion. Apparatus 500 is similar to apparatus 400 except for including two LBO crystals 130(1) and 130(2). Both LBO crystals 130 are positioned in the propagation path of intracavity mid-IR beam 480 in resonator 422. The first LBO crystal 130(1) generates an intermediate cw DUV laser beam 592 from initial DUV beam 470 and intracavity mid-IR beam 480. The second LBO crystal 130(2) generates DUV output beam 490 from intermediate DUV beam 592 and intracavity mid-IR beam 480.

Since apparatus 500 incorporates two sequential sum-frequency generation stages, apparatus 500 may be suitable for reaching further into the DUV range than apparatus 400 and/or operate with an embodiment of DUV source 410 that generates initial DUV beam 470 with a longer wavelength than in apparatus 400. Apparatus 500 is readily extendable to more than two sequential stages of sum-frequency generation in more than two respective LBO crystals 130 positioned in the propagation path of intracavity mid-IR beam 480 in resonator 422.

FIG. 6 illustrates one cw laser apparatus 600 for generating a sub-190 nm cw laser beam through two sequential intracavity sum-frequency generation stages in two separate cw mid-IR laser sources. Each of these two intracavity sum-frequency generation stages takes place in a respective LBO crystal positioned in the propagation path of an intracavity cw mid-IR laser beam. Apparatus 600 is a cw embodiment of apparatus 300 that utilizes intracavity frequency conversion. Apparatus 600 may be viewed as a modification of apparatus 500 that implements LBO crystals 130(1) and 130(2) in two separate mid-IR sources 420(1) and 420(2). Mid-IR sources 420(1) and 420(2) may have the same or different configurations. In one example, mid-IR laser sources 420(1) and 420(2) implement different solid-state gain media to generate the corresponding intracavity cw mid-IR laser beams with different respective wavelengths.

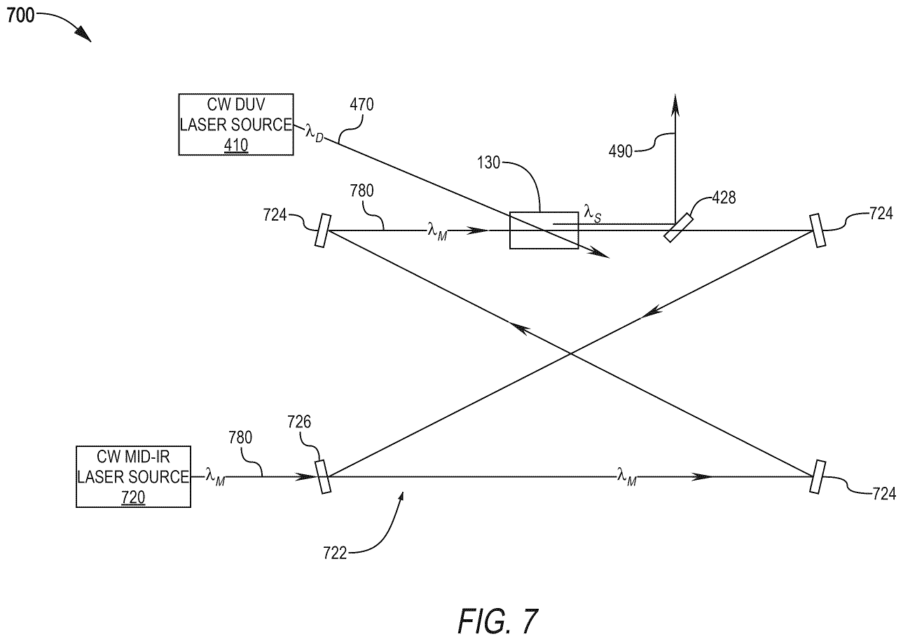

FIG. 7 illustrates one cw laser apparatus 700 for generating a sub-190 nm cw laser beam through a single stage of sum-frequency generation in an LBO crystal positioned in a resonant-enhancement cavity. Apparatus 700 is a cw embodiment of apparatus 100 that utilizes resonantly enhanced frequency conversion. Apparatus 700 includes DUV source 410, a cw mid-IR laser source 720, a resonant-enhancement cavity 722, and LBO crystal 130. LBO crystal 130 is positioned in resonant-enhancement cavity 722.

Mid-IR source 720 generates a cw mid-IR laser beam 780. Mid-IR beam 780 is coupled into resonant-enhancement cavity 722 via a coupling-mirror 726. Coupling-mirror 726 cooperates with one or more other mirrors 724 to define resonant-enhancement cavity 722. Although depicted as a ring resonator, resonant-enhancement cavity 722 may instead be a linear resonator. Due to the resonant enhancement of mid-IR beam 780 in resonant-enhancement cavity 722, the sum-frequency generation process in LBO crystal 130 benefits from relatively high mid-IR laser power. This advantage is similar to that provided by the intracavity frequency conversion in apparatus 400. Comparing apparatuses 400 and 700, apparatus 400 may be simpler to build and operate since is does not require a separate resonant-enhancement cavity in addition to the mid-IR laser resonator itself.

Apparatus 700 may be viewed as a modification of apparatus 400 that utilizes a resonantly enhanced frequency conversion rather than intracavity frequency conversion. Apparatuses 500 and 600 may be modified in a similar manner to utilize resonantly enhanced frequency conversion instead of intracavity frequency conversion.

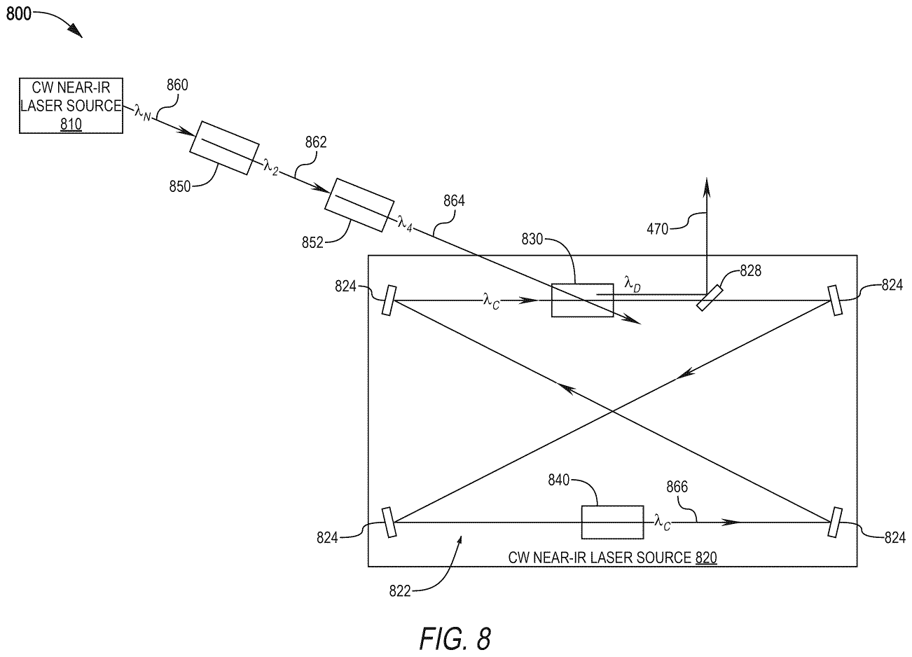

FIG. 8 illustrates one cw DUV laser source 800 that generates initial DUV beam 470 via two sequential stages of second-harmonic generation followed by intracavity sum-frequency generation. DUV source 800 is a cw embodiment of DUV source 110 and an embodiment of DUV source 410. DUV source 800 includes cw near-IR laser sources 810 and 820 and nonlinear crystals 830, 850, and 852.

Near-IR source 820 includes a laser resonator 822 and a solid-state gain medium 840 positioned in laser resonator 822. In certain embodiments, gain medium 840 is a crystal doped with optically-active ions that produce lasing action in the near-IR and thus generate an intracavity cw near-IR laser beam 866 with a near-IR wavelength λ_{C}. In one such embodiment, gain medium 840 is a crystal doped with neodymium, e.g., a neodymium-doped vanadate crystal or a neodymium-doped YAG crystal. In this embodiment, wavelength λ_{C} may be 1064 nm. In another embodiment, solid-state gain medium 840 is an optically-pumped semiconductor gain material. Resonator 822 is defined by a plurality of mirrors 824. Resonator 822 may be a ring resonator, as shown, or a linear resonator. Resonator 822 may be similar to resonator 422 of mid-IR source 420 except for being adapted to a near-IR wavelength.

Near-IR source 810 generates a cw near-IR laser beam 860 with a wavelength λ_{N}. Near-IR beam 860 undergoes second-harmonic generation in nonlinear crystal 850 to produce a second harmonic beam 862. Second harmonic beam 862 then undergoes another step of second-harmonic generation in nonlinear crystal 852 to produce a fourth harmonic beam 864. Nonlinear crystal 850 may be an LBO crystal, and nonlinear crystal 852 may be an LBO, CLBO, or BBO crystal. The wavelength λ₂ of second harmonic beam 862 may be visible, and the wavelength λ₄ of fourth harmonic beam 864 may be ultraviolet.

Nonlinear crystal 830 is positioned in the propagation path of intracavity near-IR beam 866 in resonator 822. Nonlinear crystal 830 may be a CLBO crystal. The fourth harmonic beam 864 is overlapped with intracavity near-IR beam 866 in nonlinear crystal 830 to generate initial DUV beam 470 through sum-frequency generation. In the depicted example, initial DUV beam 470 is extracted from resonator 822 by a dichroic mirror 828.

In one example, near-IR source 810 is a neodymium-YAG or neodymium-vanadate laser and λ_{N} is 1064 nm, whereby λ₂ is 532 nm and λ₄ is 266 nm. When the wavelength λ_{C} of intracavity near-IR beam 866 is 1064 nm, this results in the wavelength of λ_{D} of initial DUV beam 470 being 213 nm. In another example, near-IR source 810 is an ytterbium-YAG laser or an ytterbium-doped fiber laser and λ_{N} is 976 nm, whereby λ₂ is 488 nm and λ₄ is 244 nm. When combined with the wavelength λ_{C} of intracavity near-IR beam 866 being 1064 nm, the wavelength of λ_{D} of initial DUV beam 470 becomes 198 nm.

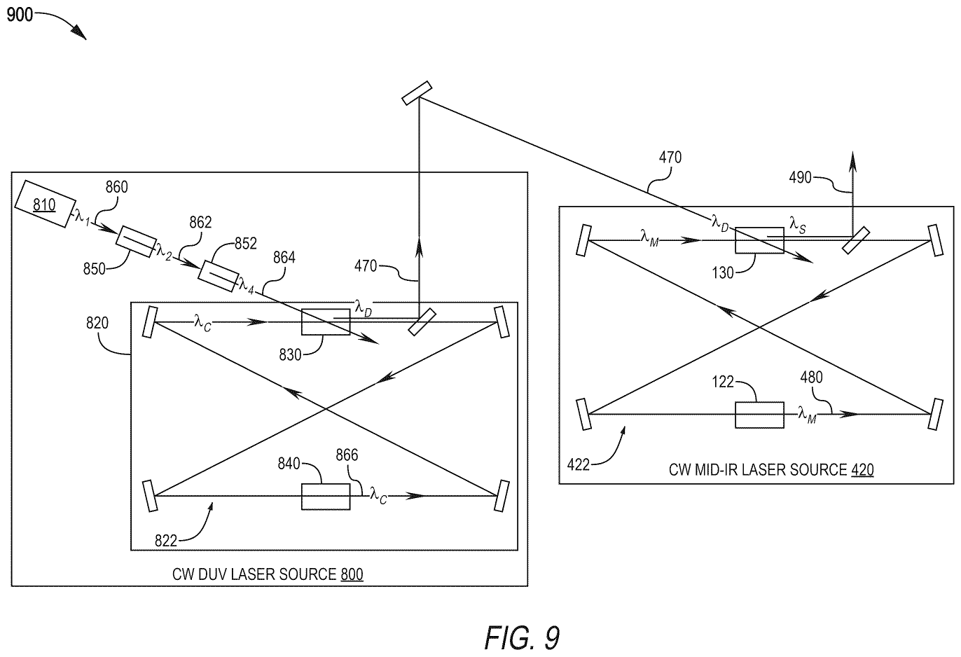

FIG. 9 illustrates one cw laser apparatus 900 for generating a sub-190 nm cw laser beam through a single stage of intracavity sum-frequency generation in an LBO crystal positioned in the laser resonator of a cw mid-IR laser source. Apparatus 900 is an embodiment of apparatus 400 that utilizes DUV source 800 to generate initial DUV beam 470. A single sum-frequency generation stage in apparatus 900 is sufficient to generate output DUV beam 490 with a wavelength λ_{S} between 179 and 184 nm when apparatus 900 implements (a) an embodiment of DUV source 800 that generates initial DUV beam 470 with a wavelength λ_{D} of 198 nm and (b) an embodiment of mid-IR source 420 that generates intracavity mid-IR beam 480 with a wavelength λ_{M} in the range between 1850 and 2600 nm.

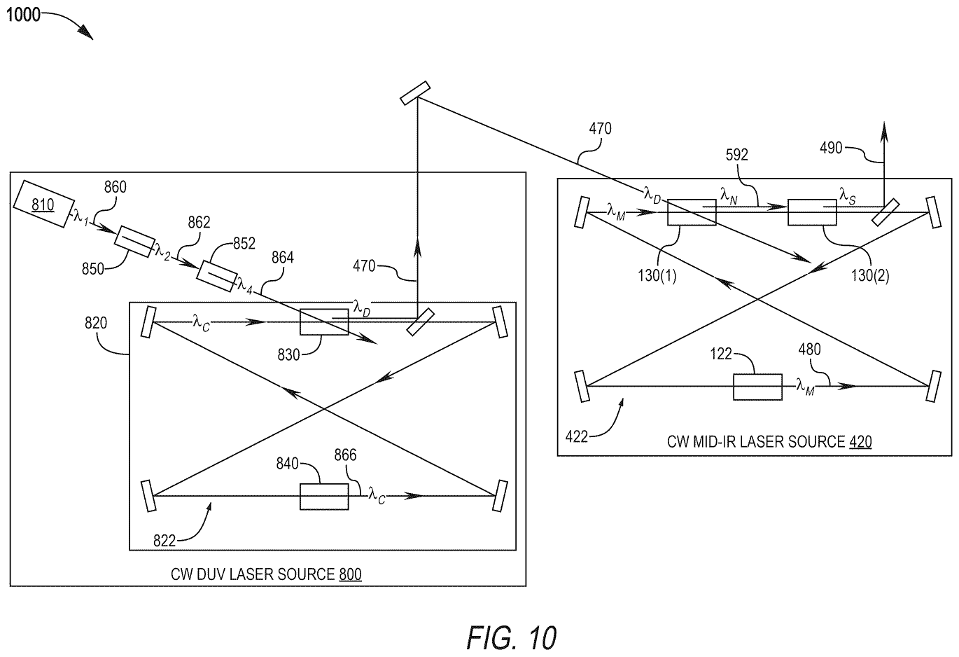

FIG. 10 illustrates one cw laser apparatus 1000 for generating a sub-190 nm cw laser beam through sequential intracavity sum-frequency generation in two LBO crystals positioned in the laser resonator of a cw mid-IR laser source. Apparatus 1000 is an embodiment of apparatus 500 that utilizes DUV source 800 to generate initial DUV beam 470. As compared to apparatus 900, the two intracavity LBO crystals 130 in apparatus 1000 makes it possible to reach further into the DUV range than in apparatus 900 and/or operate with an embodiment of DUV source 800 that generates initial DUV beam 470 with a longer wavelength than in apparatus 900.

In one example, apparatus 1000 implements (a) an embodiment of DUV source 800 that generates initial DUV beam 470 with a wavelength λ_{D} of 213 nm and (b) an embodiment of mid-IR source 420 that generates intracavity mid-IR beam 480 with a wavelength λ_{M} in the range between 1850 and 2600 nm. In this example, apparatus 1000 generates output DUV beam 490 with a wavelength λ_{S} in the range between 173 and 183 nm.

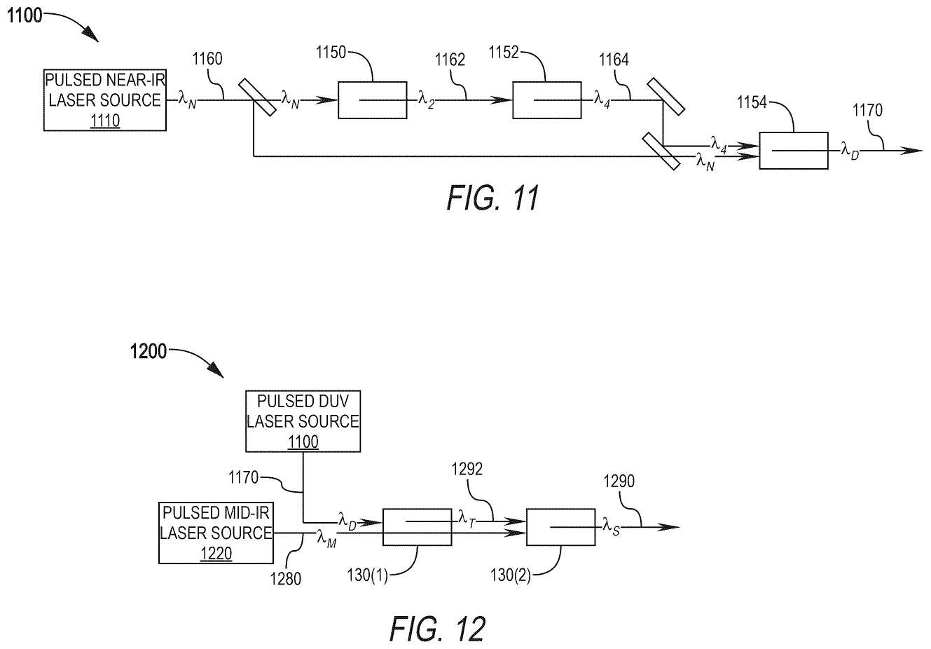

FIG. 11 illustrates one pulsed DUV laser source 1100 that generates an initial pulsed DUV beam 1170 as the fifth harmonic of a pulsed near-IR laser beam. DUV source 1100 is a pulsed embodiment of DUV source 110. DUV source 1100 includes a pulsed near-IR laser source 1110 and nonlinear crystals 1150, 1152, and 1154.

Near-IR source 1110 generates a pulsed near-IR laser beam 1160 with wavelength λ_{N}. In one embodiment, near-IR source 1110 is a nanosecond laser generating near-IR beam 1160 with a pulse duration in the nanosecond range. In another embodiment, near-IR source 1110 is a mode-locked laser producing pulse durations in the picosecond or femtosecond range. A portion of near-IR beam 1160 is directed to nonlinear crystal 1150, where this portion undergoes second-harmonic generation to produce a second harmonic beam 1162. Second harmonic beam 1162 then undergoes second-harmonic generation in nonlinear crystal 1152 to produce the fourth harmonic 1164 of near-IR beam 1160. Next, fourth harmonic beam 1164 is overlapped with another portion of near-IR beam 1160 in nonlinear crystal 1154 to produce initial DUV beam 1170 as the fifth harmonic of near-IR beam 1160. Due to the pulsed nature of near-IR beam 1160, it is not necessary to utilize intracavity frequency conversion or resonant enhancement to achieve satisfactory frequency-conversion efficiencies in nonlinear crystals 1150, 1152, and 1154.

Nonlinear crystal 1150 may be an LBO crystal, nonlinear crystal 1152 may be a CLBO or BBO crystal, and nonlinear crystal 1154 may be an LBO, BBO, or CLBO crystal. Near-IR source 1110 may be an ytterbium- or neodynium-doped solid-state laser or fiber laser, or an optically pumped semiconductor laser. Wavelength λ_{N} of near-IR beam 1160 may be in the range between 1000 and 1100 nm, whereby wavelength λ_{D} of initial DUV beam 1170 is in the range between 200 and 220 nm.

FIG. 12 illustrates one pulsed laser apparatus 1200 for generating a sub-190 nm pulsed laser beam through sequential sum-frequency generation in two LBO crystals. Apparatus 1200 is a pulsed embodiment of apparatus 200 that utilizes DUV source 1100 to generate a pulsed embodiment of initial DUV beam 170. Apparatus 1200 includes DUV source 1100, a pulsed mid-IR laser source 1220, and two LBO crystals 130(1) and 130(2).

Mid-IR source 1220 is an embodiment of mid-IR source 120 that generates a pulsed mid-IR laser beam 1280. Sum-frequency generation in LBO crystal 130(1) generates an intermediate pulsed DUV beam 1292 from mid-IR beam 1280 and initial DUV beam 1170. Sum-frequency generation in LBO crystal 130(2) then generates a pulsed DUV output laser beam 1290 from intermediate DUV beam 1292 and a remaining portion of mid-IR beam 1280. In the depicted example, the remaining portion of mid-IR beam 1280 is a portion of mid-IR beam 1280 that has passed through LBO crystal 130(1) without being frequency converted. Alternatively, this portion of mid-IR beam 1280 may have been split off prior to LBO crystal 130(1). Intermediate DUV beam 1292 and DUV output beam 1290 are pulsed embodiments of intermediate DUV beam 292 and DUV output beam 190, respectively. Since mid-IR beam 1280 and initial DUV beam 1170 are pulsed, a single pass through each LBO crystal 130 of the laser beams contributing to sum-frequency generation process is sufficient.

In one example, apparatus 1200 generates (a) initial DUV beam 1170 with wavelength λ_{D} in the range between 200 and 225 nm and (b) mid-IR beam 1280 with wavelength λ_{M} in the range between 1850 and 2100 nm. In this example, wavelength λ_{T} of intermediate DUV beam 1292 may be in the range between 180 and 199 nm, and wavelength λ_{S} of DUV output beam 1290 may be in the range between 164 and 182 nm.

In a modification of apparatus 1200, the second LBO crystal 130(2) is omitted, and apparatus 1200 is configured to generate intermediate DUV beam 1292 with wavelength λ_{T} being in the range between 180 and 190 nm. In this modification, intermediate DUV beam 1292 may be used as the sub-190 nm DUV output beam.

The present approach to sub-190 nm DUV laser beam generation, based on (a) mid-IR laser beam generation in a solid-state laser with a holmium-, thulium-, or chromium-doped gain crystal/fiber or an optically-pumped semiconductor gain material and (b) sum-frequency mixing of the generated mid-IR laser beam with a DUV laser beam in an LBO crystal, is not limited to the architectures discussed above in reference to FIG. 4-12. The present approach may be implemented with other architectures as well, including those known in the prior art.

The present invention is described above in terms of a preferred embodiment and other embodiments. The invention is not limited, however, to the embodiments described and depicted herein. Rather, the invention is limited only by the claims appended hereto.

What is claimed is:

1. A laser apparatus for generating a sub-190 nanometer laser beam, comprising:
a deep-ultraviolet solid-state laser source to generate an initial deep-ultraviolet laser beam;
at least one mid-infrared solid-state laser source to generate at least one respective mid-infrared laser beam, each of the at least one mid-infrared solid-state laser source including (a) a respective holmium-, thulium-, or chromium-doped gain crystal or gain fiber or (b) a respective optically-pumped semiconductor gain material to generate the respective mid-infrared laser beam; and
at least one lithium triborate crystal to generate an output deep-ultraviolet laser beam from the initial deep-ultraviolet and mid-infrared laser beams via sum-frequency generation, the output deep-ultraviolet laser beam having a wavelength shorter than 190 nanometers.

2. The laser apparatus of claim 1, wherein the sum-frequency generation in each of the at least one lithium triborate crystal utilizes one of the at least one mid-infrared laser beam, the sum-frequency generation in a first one of the at least one lithium triborate crystal utilizes also the initial deep-ultraviolet laser beam, and the sum-frequency generation in any non-first one of the at least one lithium triborate crystal utilizes also an intermediate deep-ultraviolet laser beam generated by sum-frequency generation in a preceding one of the at least one lithium triborate crystal.

3. The laser apparatus of claim 1, wherein the initial deep-ultraviolet laser beam has a wavelength between 190 and 230 nanometers.

4. The laser apparatus of claim 1, wherein the mid-infrared laser beam generated by each of the at least one mid-infrared solid-state laser source has a wavelength between 1850 and 2600 nanometers.

5. The laser apparatus of claim 1, wherein the at least one mid-infrared solid-state laser source consists of a single mid-infrared solid-state laser source, and the at least one lithium triborate crystal consists of a single lithium triborate crystal.

6. The laser apparatus of claim 1, wherein:
the at least one lithium triborate crystal includes a series of lithium triborate crystals such that the output deep-ultraviolet laser beam is a product of sequential sum-frequency generation in the series of lithium triborate crystals;
the at least one mid-infrared solid-state laser source consists of a single mid-infrared solid-state laser source generating a single mid-infrared laser beam; and
the sum-frequency generation in each of the lithium triborate crystals of the series utilizes the single mid-infrared laser beam.

7. The laser apparatus of claim 1, wherein:
the at least one lithium triborate crystal includes a series of lithium triborate crystals such that the output deep-ultraviolet laser beam is a product of sequential sum-frequency generation in the series of lithium triborate crystals;
the at least one mid-infrared solid-state laser source includes a series of mid-infrared solid-state laser sources generating a respective series of mid-infrared laser beams; and
the sum-frequency generation in each of the lithium triborate crystals of the series utilizes a respective one of the series of mid-infrared laser beams.

8. The laser apparatus of claim 1, wherein the deep-ultraviolet and mid-infrared solid-state laser sources are continuous-wave laser sources, and the mid-infrared laser beam, the initial deep-ultraviolet laser beam, and the output deep-ultraviolet laser beam are continuous-wave laser beams.

9. The laser apparatus of claim 8, wherein:
the at least one mid-infrared solid-state laser source consists of a single mid-infrared solid-state laser source generating a single mid-infrared laser beam as an intracavity laser beam propagating in a laser resonator of the single mid-infrared solid-state laser source; and
each of the at least one lithium triborate crystal is positioned in the laser resonator in a propagation path of the intracavity laser beam.

10. The laser apparatus of claim 9, wherein the at least one lithium triborate crystal consists of a single lithium triborate crystal.

11. The laser apparatus of claim 10, wherein the deep-ultraviolet solid-state laser source includes:
a first solid-state laser source to generate a first near-infrared continuous-wave laser beam;
a plurality of nonlinear crystals to generate a fourth harmonic of the first near-infrared continuous-wave laser beam;
a second solid-state laser source; and
an additional nonlinear crystal positioned in a laser resonator of the second solid-state laser source to generate the initial deep-ultraviolet laser beam from sum-frequency mixing of an intracavity near-infrared continuous-wave laser beam, propagating in the laser resonator of the second solid-state laser source, and the fourth harmonic of the first near-infrared continuous-wave laser beam.

12. The laser apparatus of claim 11, wherein the initial deep-ultraviolet laser beam has a wavelength of less than 200 nanometers.

13. The laser apparatus of claim 9, wherein the at least one lithium triborate crystal includes a series of lithium triborate crystals such that the output deep-ultraviolet laser beam is a product of sequential sum-frequency generation in the series of lithium triborate crystals.

14. The laser apparatus of claim 13, wherein the deep-ultraviolet solid-state laser source includes:
a first solid-state laser source to generate a first near-infrared continuous-wave laser beam;
a plurality of nonlinear crystals to generate a fourth harmonic of the first near-infrared continuous-wave laser beam;
a second solid-state laser source with a laser resonator and an ion-doped gain medium, disposed in the laser resonator, to generate a second near-infrared continuous-wave laser beam as an intracavity laser beam propagating in the laser resonator; and
an additional nonlinear crystal positioned in a laser resonator of the second solid-state laser source to generate the deep-ultraviolet laser beam from sum-frequency mixing of an intracavity near-infrared continuous-wave laser beam, propagating in the laser resonator of the second solid-state laser source, and the fourth harmonic of the first near-infrared continuous-wave laser beam.

15. The laser apparatus of claim 14, wherein the deep-ultraviolet laser beam has a wavelength between 210 and 225 nanometers.

16. The laser apparatus of claim 8, wherein:
the at least one mid-infrared solid-state laser source includes a series of mid-infrared solid-state laser sources generating a respective series of mid-infrared laser beams, each mid-infrared laser beam of the series being an intracavity laser beam propagating in a laser resonator of the respective mid-infrared solid-state laser source; and
the at least one lithium triborate crystal includes a series of lithium triborate crystals such that the output deep-ultraviolet laser beam is a product of sequential sum-frequency generation in the series of lithium triborate crystals, each lithium triborate crystal of the series of lithium triborate crystals being positioned in the laser resonator of a respective one of the mid-infrared solid-state laser sources.

17. The laser apparatus of claim 8, wherein the at least one mid-infrared solid-state laser source consists of a single mid-infrared solid-state laser source generating a single mid-infrared laser beam, the laser apparatus further comprising a single resonant-enhancement cavity to resonantly enhance the single mid-infrared laser beam, each of the at least one lithium triborate crystal being positioned in the single resonant-enhancement cavity in a propagation path of the single mid-infrared laser beam as resonantly enhanced.

18. The laser apparatus of claim 17, wherein the at least one lithium triborate crystal consists of a single lithium triborate crystal.

19. The laser apparatus of claim 17, wherein the at least one lithium triborate crystal includes a series of lithium triborate crystals such that the output deep-ultraviolet laser beam is a product of sequential sum-frequency generation in the series of lithium triborate crystals.

20. The laser apparatus of claim 8, wherein:
the at least one lithium triborate crystal includes a series of lithium triborate crystals such that the output deep-ultraviolet laser beam is a product of sequential sum-frequency generation in the series of lithium triborate crystals;
the at least one mid-infrared solid-state laser source consists of a single mid-infrared solid-state laser source generating a single mid-infrared laser beam;
the laser apparatus further comprises a series of resonant-enhancement cavities to resonantly enhance respective portions of the single mid-infrared laser beam; and
each lithium triborate crystal of the series is positioned in a respective one of the resonant-enhancement cavities in a propagation path of the respective portions of the single mid-infrared laser beam as resonantly enhanced.

21. The laser apparatus of claim 1, wherein the initial deep-ultraviolet and mid-infrared solid-state laser sources are pulsed laser sources, and the mid-infrared laser beam, the initial deep-ultraviolet laser beam, and the output deep-ultraviolet laser beam are pulsed laser beams.

22. The laser apparatus of claim 21, wherein each laser beam contributing to sum-frequency generation in each of the least one lithium triborate crystal makes only a single pass through the respective lithium triborate crystal.

23. The laser apparatus of claim 21, wherein the at least one lithium triborate crystal consists of a single lithium triborate crystal.

24. The laser apparatus of claim 21, wherein the at least one lithium triborate crystal includes a series of lithium triborate crystals such that the output deep-ultraviolet laser beam is a product of sequential sum-frequency generation in the series of lithium triborate crystals.

25. The laser apparatus of claim 24, wherein the at least one mid-infrared solid-state laser source consists of a single mid-infrared solid-state laser source generating a single mid-infrared laser beam.

26. The laser apparatus of claim 25, wherein:
the single mid-infrared laser beam has a wavelength between 200 and 220 nanometers;
the at least one lithium triborate crystal includes a series of two lithium triborate crystals such that the deep-ultraviolet output laser beam is a product of sequential sum-frequency generation in the two lithium triborate crystals; and
the output deep-ultraviolet laser beam has a wavelength between 164 and 182 nanometers.

27. The laser apparatus of claim 21, wherein the deep-ultraviolet solid-state laser source includes:
a solid-state laser source with an ion-doped gain medium to generate a near-infrared pulsed laser beam; and
a plurality of nonlinear crystals to generate the initial deep-ultraviolet laser beam as a fifth harmonic of the near-infrared pulsed laser beam.
